(19) United States
(12) Patent Application Publication
(10) Pub. No.: US 2014/0218936 A1
(43) Pub. Date: Aug. 7, 2014

(54) TRANSPORTABLE LIGHTING DEVICE

(71) Applicant: Wacker Neuson Produktion GmbH & Co. KG, Munchen (DE)

(72) Inventors: Eva Mahling, Munich (DE); Christian Hartkopf, Haimhausen (DE)

(73) Assignee: Wacker Neuson Produktion GmbH & Co. KG, Munchen (DE)

(21) Appl. No.: 14/165,811

(22) Filed: Jan. 28, 2014

(30) Foreign Application Priority Data
Feb. 7, 2013 (DE) 102013002202.9

(51) Int. Cl. F21V 23/02; F21V 21/22; F21V 17/04; F21L 14/00; F21V 11/00

(52) U.S. Cl. CPC F21V 23/026; F21L 14/00; F21V 11/00; F21V 17/04; F21V 21/22
USPC 362/311.01; 362/431; 362/418

(57) ABSTRACT

A transportable lighting device has a light apparatus, a column device that bears the light apparatus and that extends in a longitudinal direction, and a stand device that bears the column device. In order to provide electrical power for the light apparatus, a ballast is provided that is situated on the column device, underneath the column device in the longitudinal direction. In this way, the overall center of gravity of the transportable lighting device can be shifted significantly downward, This results in improved stability against falling.

### BACKGROUND OF THE INVENTION

1. Field of the Invention

The present invention relates to a transportable lighting device.

2. Description of the Related Art

Transportable lighting devices are known, as stand lights, and are used for example for temporary illumination of a construction site an accident site, or a work site

EP 1 059 483 A2 indicates such a transportable lighting device. The lighting device is made up essentially of a light balloon having a light source, for example a metal vapor halogen lamp (also known as a metal-halide lamp), and a stand having an extendable telescope with the aid of which the height of the light balloon having the light source can be adjusted. In this way, it is possible to extend the telescope far enough that the light source reaches a height of 4 to 5 m, in order to achieve a uniform illumination of the work site.

In addition, a ballast is standardly provided that is required in order to provide electric power, and thus for the operation of the metal vapor halogen lamp.

The components are realized, with regard to their dimensions and their weight, in such a way that they can be easily carried by one person. In this way, the lighting device can be comfortably brought from one location to another.

In known lighting devices, the light balloon with the lighting device is placed onto the stand and is electrically connected to the ballast. The ballast is in turn connected to the electrical power supply present at the work site or construction site, and is usually placed on the ground next to the stand.

In the completely extended state of the stand, or of the telescope, in known lighting devices a height of the light source of from 4 to 5 m is usually achieved. The light balloon surrounding the actual light source (lamp) presents a good surface for contact by wind due to its dimensions. The light balloon, made for example of a fabric, surrounds the light source and thus brings about a uniform, non-blinding light distribution, as well as a lower light density of the lamp. In this way, the quality of the illumination can be significantly improved. Such a light balloon is indicated in EP 1 059 483 A2.

Due to the additional weight of the light balloon, which surrounds the lamp also at a significant height, the lighting device has a relatively high center of gravity. The large wind contact surface of the light balloon, together with the high center of gravity and the large lever effect present when the telescope elements are extended, requires, under windy work conditions, additional securing measures such as bracing with guy cables. This is intended to prevent the stand, or the entire lighting device, from easily falling over. When the lighting device is braced with guy cables, the cables (for example three cables) extend from the vertical telescope column and must he fastened to the ground using pegs. This does prevent the lighting device from falling over under the influence of wind. However, the cables can be stumbled over, and thus present an accident hazard for persons working near the lighting device. In addition, on some surfaces, for example asphalt or concrete, it is not easily possible to drive pegs into the ground.

If, however, the lighting device is not braced against falling by cables, there is the danger that the device can tip over even in light wind.

Therefore, the object of the present invention is to indicate a lighting device that has increased stability without having to secure the device using guy cables.

### SUMMARY OF THE INVENTION

According to an aspect of the present invention, a mobile or transportable lighting device has a light apparatus, a column device that bears the light apparatus and that extends in a longitudinal direction, a stand device that bears the column device, and a ballast for providing electric power to the light apparatus. The lighting device is characterized in that the ballast is situated on the column device, underneath the column device in the longitudinal direction.

Thus, according to the present invention is provided that the ballast is not placed on the ground next to the lighting device, as in the existing art, but rather is situated on the column device, underneath it. Due to its constructive design, for example as a magnetic series transformer, the ballast has significant weight, for example from 8 to 15 kg. In addition to this there is the weight of the housing of the ballast, which has to be suitable for use on construction sites and is therefore robust and heavy. Overall, the ballast has a significant weight that, due to the fact that it is situated on the column device and underneath it, significantly lowers the center of gravity and thus increases the stability of the lighting device against falling. In this way, the overall center of gravity of the lighting device can be shifted downward.

In particular, the ballast can be situated on the lower end of the column device, extending the longitudinal axis of the column device. Given an operational design of the lighting device, in a preferred specific embodiment the center of gravity of the ballast is situated essentially vertically below the center of gravity of the column device, in order in this way to lower the overall center of gravity.

The ballast can be fastened on the column device. In particular, it is possible for the ballast to be detachably fastened on the column device, so that the ballast and the column device, or the ballast and the stand device, can be separated from one another when the lighting device is not being used, so that the individual components can again be carried easily by one person.

The light apparatus can have at least one light generator and a light screen that surrounds at least a part of the light generator and is at least partly transparent to light. In this way, the light apparatus can be fashioned as a so-called light balloon, as is also known for example from EP 1 059 483 A2.

The light screen can be made up of an elliptical or spherical balloon sheath that completely surrounds the light generator, for example a metal vapor halogen lamp, also known as a metal-halide lamp. It is also possible for the light screen or the balloon sheath to be made up of two halves, of which for example the upper half is made of a reflective textile material and the lower half is made of a material transparent to light. The light emitted by the light generator is then reflected downward by the reflective material of the upper half, and in this way reinforces the light that is already exiting directly through the lower half.

The light apparatus can have a clamp, the clamp being capable of being fixed in a clamped state in which the clamp clamps the light screen in order to hold the light screen in an open state ready for use, and the clamp being capable of being moved into a release state in which the clamp does not clamp the light screen. Using the clamp, in this way the light screen can he clamped in the manner of a balloon so that the screen material does not come into contact with the light generator, which becomes very hot during operation. Rather, in the clamped state the light screen surrounds the light generator at a certain distance, so that a uniform emanation of light can be achieved.

The column device can be a telescope device having at least two telescope elements that can be moved into one another in a linear fashion. In practice, it has turned out that a satisfactory lamp height can be achieved with the use of three telescope elements. The displacement into one another of the telescope elements makes it possible for the column device to have a relatively compact construction, and therefore to be easily transported. The desired working height of the light apparatus is then achieved by extending the telescope elements.

The stand device can have an upper mount that is situated in axially displaceable fashion on the column device, as well as a lower mount that is situated in the region of a lower end of the column device, and can have at least three stand legs, of which one end is pivotably fashioned to the upper mount, and can have for each of the stand legs a strut of which one end is pivotable on the lower mount and the other end is pivotable on the associated stand leg.

Due to the at least three stand legs, the stand device ensures a secure standing, so that the column device borne by the stand device can be held securely upright even when the column device, or the telescope elements of the column device, are extended to the full working height. Through the situation of the upper mount, the lower mount, the three stand legs, and the respectively associated struts, a robust bearing structure is erected that can reliably hold the lighting device upright even if it has a great weight. In addition, the pivotability of the stand legs and of the struts ensures that when the upper mount is lifted, or axially displaced upward, the stand device can be folded together. This facilitates the transport of the lighting device.

In a variant, the lower mount can also be situated on the column device so as to be capable of being displaced.

On the upper mount, a stop can be provided for at least one of the stand legs in order to limit a pivoting movement of the stand leg away from the longitudinal axis. The stand leg can then be pivoted, only until it meets the stop. This position should then correspond to the desired final position that the stand leg is to assume for the secure supporting of the column device.

On the lower mount, a stop can he provided for at least one of the struts in order to limit a pivoting movement of the strut. The strut, or all the struts if all struts are provided with stops, can in this way be limited in its pivoting movement, so that in the operational state all struts and all stand legs lie against their respective stops and cannot be farther pivoted. In this way, the overall bearing structure is additionally stabilized.

In a specific embodiment, the ballast can be held on the column device by a holding device. The holding device thus creates a connection between the column device and the ballast, and ensures that the ballast is held underneath the column device.

In an alternative solution, a bearing device can be provided for bearing the ballast underneath the column device. The bearing device can for example be realized in the manner of a tablet, so that the ballast has to be placed on it in order to achieve the desired lowering of the center of gravity.

In another specific embodiment, the ballast has a suspension device, the holding device being capable of being connected to the suspension device in order to hold the ballast.

The suspension device can have a handle device for bearing the ballast, the holding device being fashioned in order to hold the handle device. This means that the handle device, standardly already provided on a ballast in order to facilitate the transporting of the heavy ballast, can also be coupled to the holding device, so that the holding device holds the ballast by its handle device. In this way, the ballast, or the housing of the ballast, does not have to be modified in any particular way.

The holding device can have a hanger for hanging the handle device of the ballast, or can have a guide device for the linear insertion of the handle device. A correspondingly fashioned hook can for example be provided on the hanger, on which hook the handle is hung. In contrast, the guide device enables the insertion or introduction of the handle device. For example, the guide device can be fashioned in the form of a dovetail guide extending transverse to the longitudinal axis of the column device, The handle device can then correspondingly be pushed into the guide laterally, i.e. perpendicular to the longitudinal axis of the column device. The guide device enables a quick fastening of the ballast on the column device. At the same time, however, the ballast can remain fastened on the column device reliably and over a long term.

On the holding device, a locking device can be provided for locking the handle device in the guide device, in a specified holding position on the holding device. The locking device is thus capable of locking the handle device in such a way that an undesired separation of the ballast from the holding device or from the column device is always prevented. Only by releasing the locking device is it possible to push the handle device out of the guide device and to remove the ballast. The locking device can for example have a snap device, so that when the handle device is pushed into the guide device, the locking device snaps in when it reaches a particular position, whereupon the handle device, with the ballast, is secured on the column device with a positive fit, By releasing the snap connection, the ballast can then be pushed out of the guide device.

In a specific embodiment, the holding device can be fashioned below the lower mount of the stand device. In this way, it is possible to provide the holder device, and therewith—when constructed as intended—the ballast as well, at as low a position as possible.

In a specific embodiment, the holding device and the lower mount are fashioned in one piece. This can achieve a very compact construction, and can reduce the overall constructive outlay. These and additional advantages and features are explained in more detail in the following on the basis of examples, with reference to the accompanying Figures.

### BRIEF DESCRIPTION OF THE DRAWINGS

FIG. 1 shows a lateral perspective view of a mobile or transportable lighting device;

FIG. 2 shows a column device and a stand device in the operational state (a) and in the folded-together state (b);

FIG. 3 shows a handle device of a ballast in the separated state (a) and in the suspended state (b);

FIG. 4 shows a handle device in the held state; and

FIG. 5 shows a partial section through a handle device.

### DETAILED DESCRIPTION OF THE PREFERRED EMBODIMENT

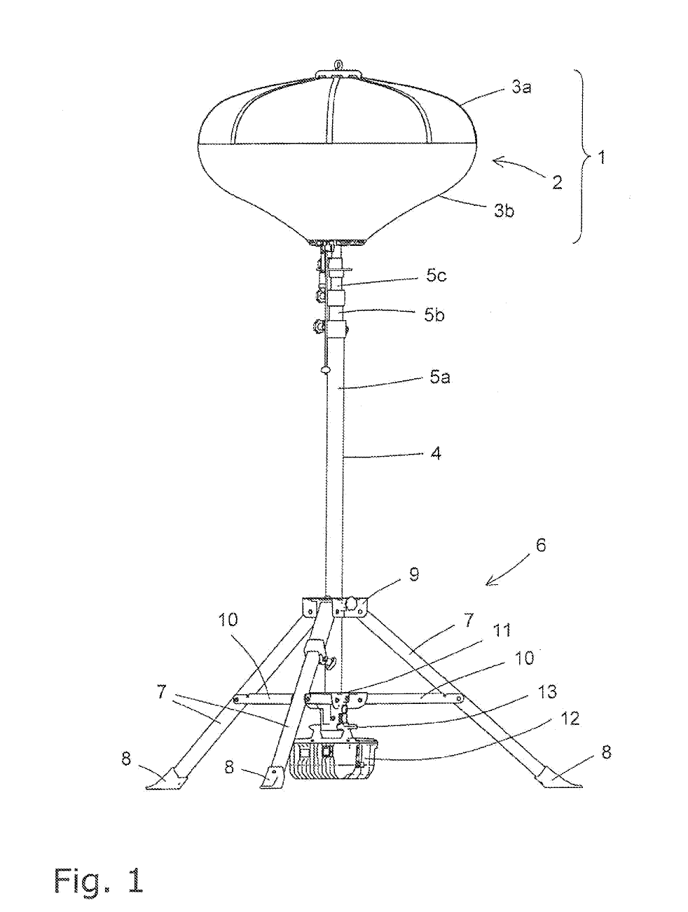

FIG. 1 shows a transportable lighting device in the operational state.

The lighting device can be carried comfortably by a user—possibly broken clown into a few components—to the location of use, or to different locations.

In the upper part of the image, a light apparatus 1 realized as a light balloon is shown. The light apparatus has in its interior a light generator (not shown) that is surrounded almost completely by a light screen 2.

Light screen 2 is clamped, by clamp (also not shown), in the clamped state shown in FIG. 1, so that it takes on an outer contour resembling an ellipse. Light screen 2 has an upper half 3a made of a reflective fabric, and a lower half 3b made of a material transparent to light.

The light produced in the interior of light apparatus 1 by the light generator, such as a lamp, thus radiates almost completely downward, and illuminates the work area situated underneath.

Light apparatus 1 is borne at its lower side by a column device 4. Column device 4 can be fashioned as a telescope device and can have a plurality of telescope elements that can be moved into one another. In the depicted example, three telescope elements 5a, 5b, 5c are provided that can be pushed into one another m linear fashion and can be locked in theft respective relative positions. Corresponding telescope devices are known, so that further description is not required here.

Column device 4 is borne by a stand device 6, and in particular is prevented from falling.

Stand device 6 has three stand legs 7, situated around the circumference at intervals of 120°. In this way stand device 6 is supported on the ground by three stand feet 8 provided at the ends of stand legs 7, enabling a secure and defined standing state in the sense of a tripod.

The ends of stand legs 7 situated opposite stand feet 8 are pivotably linked to an upper mount 9. A respective strut 10 is pivotably linked with its one end approximately in the center of each stand leg 7, and the other end of each strut extends to a lower mount 11.

Through the interaction of upper mount 9, lower mount 11, stand legs 7, and struts 10, a stable bearing structure is formed that reliably holds column device 4, which stands upright,

Lower mount 11 is fastened in stationary fashion on the lower end of column device 4, while upper mount 9 surrounds column device 4 and can be moved back and forth axially thereon, in the longitudinal direction of column device 4. In this way, stand device 6 can be modified between the operational position shown in FIG. 1 and a transport position in which stand device 6 is folded together. In the transport position, upper mount 9 on column device 4 is displaced upward, whereupon stand legs 7 come to lie against column device 4 through the guidance of struts 10.

Stand legs 7 can be realized as rectangular tubes, while struts 10 are fashioned in the form of U-shaped profiles. In this way, it is possible, in the folded-together transport state, for stand legs 7 to come to lie between the limbs of the U-shaped profile of struts 10, and in this way the construction in the folded-together state can be made still more compact.

On lower mount 11, or more precisely underneath lower mount 11, a ballast 12 is suspended. Ballast 12 acts as a transformer for providing corresponding power for light apparatus 1. The ballast is connected to the construction site power network, to a public power network, or to a power generator, and converts the power in a suitable manner. It is also used to power the light generator in light apparatus 1.

Ballast 12 has significant weight. Due to the fact that it is fastened on the lower end of column device 4, the overall center of gravity of the lighting device is shifted downward, which significantly increases its standing stability and thus, for example, its stability against wind.

Ballast 12 has a handle 13 by which ballast 12 can be comfortably carried. At the same time, handle 13 is used to fasten ballast 12 on column device 4, as is shown in FIG. 1.

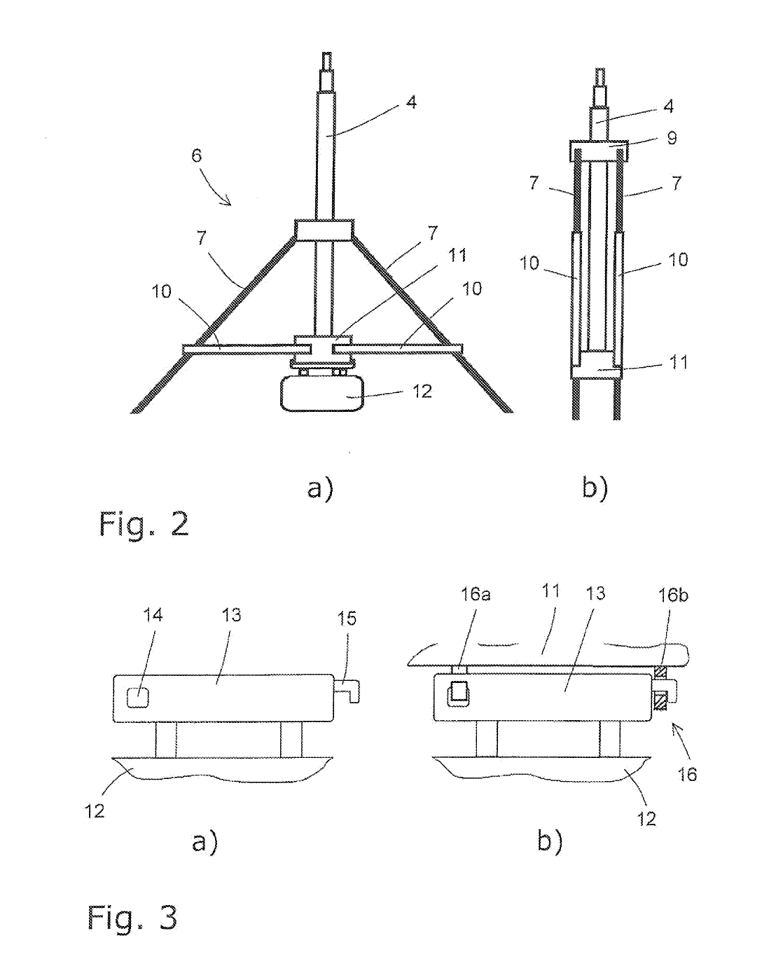

FIG. 2 schematically shows column device 4 with stand device 6 in the operational state corresponding to FIG. 1 (FIG. 2a), and in the folded-together transport state (FIG. 2b). Because the principle of the opening and closing of stand device 6 was already described above, the description is not repeated here.

However, it is to be noted that in the opened operational state of stand device 6, ballast 12 is fastened on lower mount 11. In order to reach the transport state, ballast 12 must previously be removed from lower mount 11. In this way, stand device 6 can be comfortably transported with column device 4.

FIG. 3 schematically shows an example of the fastening of ballast 12 on lower mount 11.

In FIG. 3a, it can be seen that handle 13 is fashioned on the upper side of ballast 12. Handle 13 has an opening 14 and a hook element 15.

Correspondingly, a holding device 16 is fashioned on lower mount 11 (FIG. 3b), the holding device having a hook 16a and an eye 16b. Opening 14 of handle 13 can be hung on hook 16a in order to fasten ballast 12 on lower mount 11, while hook element 15 of handle 13 is inserted into eye 16b and likewise hooks there.

The interaction of opening 14 and hook element 15 on the one hand, and of hook 16a and eye 16h on the other hand, results in a positive-fit connection between ballast 12, or handle 13 thereof, and lower mount 11.

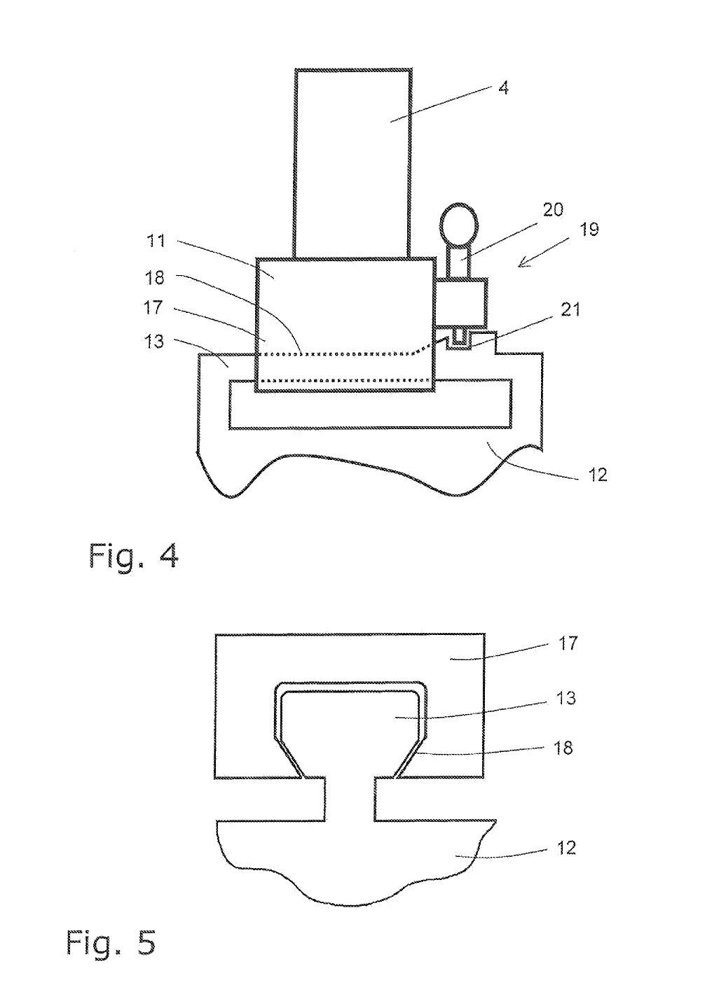

FIG. 4 shows a variant of the fastening of handle 13 of ballast 12 on lower ant 11, in a schematic view. FIG. 5 shows a partial section through handle 13.

The lower region of lower mount 11 is fashioned as holding device 17, In holding device 17, a dovetail groove 18, acting as a guide device, is fashioned into which handle 13 can be pushed from the side. Handle 13 has a cross-sectional profile that is adapted in such a way that a dovetail effect can be achieved between handle 13 and dovetail groove 18, as is shown in FIG. 5.

After handle 13 is pushed into dovetail groove 18, ballast 12 is already fastened with a positive fit on mount 11, and thus on column device 4.

For further securing, a locking device 19, shown in FIG. 4, is provided that has a spring-loaded pin 20 whose end locks into a recess 21 in handle 13 when handle 13 is pushed into dovetail groove 18 (from right to left in FIG. 4).

For release, spring-loaded pin 20 is lifted so that it is moved out of recess 21. Handle 13, with ballast 12, can then be pushed out of dovetail groove 18.

In a specific embodiment not shown in the Figures, the ballast is not suspended underneath the column device, but rather is borne by a bearing device, by placing the ballast onto this bearing device. The bearing device can for example provide a tablet-type plateau onto which the ballast can be placed. Here, the bearing device should also be situated vertically underneath the column device, so that in this way as well the ballast, when put into place, can bring about a lowering of the overall center of gravity.

In the specific embodiments described and shown in the Figures, in each case ballast 12 was suspended by its handle 13. In a variant not shown, in addition to handle 13 a separate suspension device is provided by which ballast 12 can be suspended on column device 4 or holding device 17.

In a further variant, it is possible for the center of gravity of ballast 12 to be not situated vertically underneath column device 4, but rather offset laterally to some extent, so that the center of gravity of ballast 12 is situated eccentrically to column device 4. In this way as well, the overall center of gravity can be lowered, and the stability of the lighting device can be increased.

In addition, in another variant, also not shown, it is possible to fasten ballast 12 on column device 4 or on stand device 6 with the aid of wires or cables.

All of these variants have in common that the overall center of gravity of the lighting device can be displaced downward with the aid of the mass of the ballast.

What is claimed is:

1. A transportable lighting device, comprising:
a light apparatus,
a column device that bears the light apparatus and that extends in a longitudinal direction;
a stand device that bears the column device; and
a ballast that provides electrical power for the light apparatus; wherein
the ballast is situated on the column device, underneath the column device in the longitudinal direction.

2. The transportable lighting device as recited in claim 1, wherein the ballast is detachably fastened on the column device.

3. The transportable lighting device as recited in claim 1, wherein the light apparatus has
at least one light generator; and
a light screen that surrounds at least a part of the light generator and is at least partly transparent to light.

4. The transportable lighting device as recited in claim 3, wherein
the lighting device has a clamp,
the clamp is capable of being fixed in a clamping state in which the clamp clamps the light screen, in order to hold the light screen in an open state ready for use; and wherein
the clamp can be moved into a release state in which the clamp does not clamp the light screen.

5. The transportable lighting device as recited in claim 1, wherein the column device is a telescope device having at least two telescope elements that can be displaced into one another in linear fashion.

6. The transportable lighting device as recited in claim 1, wherein the stand device has:
an upper mount situated in axially displaceable fashion on the column device;
a lower mount situated in the region of a lower end of the column device;
at least three stand legs of which one end is pivotably fastened on the upper mount; and
for each of the stand legs, a strut is allocated which has one end pivotably fastened on the lower mount and another end pivotably fastened on the associated stand leg.

7. The transportable lighting device as recited in claim 6, wherein a stop is provided on the upper mount for at least one of the stand legs in order to limit a pivoting movement of the stand leg away from the longitudinal axis,

8. The transportable lighting device as recited in claim 6, wherein a stop is provided on the lower mount for at least one of the struts, in order to limit a pivoting movement of the strut,

9. The transportable lighting device as recited in claim 1, wherein the ballast is held on the column device by a holding device.

10. The transportable lighting device as recited in claim 1, wherein
the ballast has a suspension device; and wherein
the holding device can be connected to the suspension device in order to hold the ballast.

11. The transportable lighting device as recited in claim 1, wherein
the suspension device has a handle device for bearing the ballast; and wherein
the holding device is fashioned in order to hold the handle device.

12. The transportable lighting device as recited in claim 11, wherein the holding device has one of
a hanger device for hanging the handle device of the ballast; and
a guide device for the linear pushing in of the handle device.

13. The transportable lighting device as recited in claim 11, wherein, on the holding device, there is provided a locking device for locking the handle device in the guide device in a specified holding position on the holding device.

14. The transportable lighting device as recited in claim 11, wherein the holding device is fashioned underneath the lower mount.

15. The transportable lighting device as recited in claim 11, wherein the holding device and the lower mount are fashioned in one piece.
